(19) United States
(12) Patent Application Publication
(10) Pub. No.: US 2024/0319964 A1
(43) Pub. Date: Sep. 26, 2024

(54) LARGE NUMBER INTEGER ADDITION USING VECTOR ACCUMULATION

(71) Applicant: ADVANCED MICRO DEVICES, INC., Santa Clara, CA (US)

(72) Inventors: Onur Kayiran, West Henrietta, NY (US); Lee Evan Eisen, Austin, TX (US); Michael Estlick, Ft. Collins, CO (US); Jay Fleischman, Merrill, WI (US); Matthew R. Poremba, Bellevue, WA (US); Gabriel H. Loh, Bellevue, WA (US)

(21) Appl. No.: 18/126,107

(22) Filed: Mar. 24, 2023

(51) Int. Cl. G06F 7/503

(52) U.S. Cl. CPC G06F 7/503

(57) ABSTRACT

A processor includes one or more processor cores configured to perform accumulate top (ACCT) and accumulate bottom (ACCB) instructions. To perform such instructions, at least one processor core of the processor includes an ACCT data path that adds a first portion of a block of data to a first lane of a set of lanes of a top accumulator and adds a carry-out bit to a second lane of the set of lanes of the top accumulator. Further, the at least one processor core includes an ACCB data path that adds a second portion of the block of data to a first lane of a set of lanes of a bottom accumulator and adds a carry-out bit to a second lane of the set of lanes of the bottom accumulator.

### BACKGROUND

To help improve security, some processing systems include one or more processors configured to encrypt and decrypt data in the processing system using cryptographic algorithms such as Rivest-Shamir-Adleman (RSA) algorithms, digital signal algorithms (DSAs), and the like. Frequently, these cryptographic algorithms require arbitrary-precision arithmetic computations (e.g., addition, subtraction) to be performed on large number integers (e.g., 256-bit integers, 512-bit integers, 4096-bit integers) before data can be encrypted or decrypted within the processing system. To facilitate such arbitrary-precision arithmetic computations, some processors are configured to divide a large number integer into multiple blocks of data before computations are performed. Further, to determine the result of the computation on the large number integer, some instruction set architectures (ISAs) associated with the processors include one or more instructions to perform computations (e.g., addition, subtraction) on the blocks of the large number integer.

For example, within some x86 processing systems, an x86 ISA includes one or more instructions that implement scalar arithmetic to perform computations on each block of a large number integer. However, using scalar arithmetic to perform computations on a large number integer requires at least one instruction to be performed for each block of the large number integer, increasing the processing time of the computation and lowering the processing efficiency of the processing system. As another example, within some Advanced Reduced Instruction Set Computer (RISC) Machines (ARM) systems, an ARM ISA includes one or more instructions that implement vector arithmetic to perform computations on each block of a large number integer by tracking carry bits that are to be carried through the operation. However, in some cases, tracking the carry bits requires performing an instruction for each carry bit, also increasing the processing time of the computation and lowering the processing efficiency of the processing system.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system implementing accumulate top (ACCT) and accumulate bottom (ACCB) instructions for integer addition, in accordance with some implementations.

FIG. 2 is a block diagram of an example ACCT instruction, in accordance with some implementations.

FIG. 3 is a block diagram of an example ACCB instruction, in accordance with some implementations.

FIG. 4 is a block diagram of an example ACCT data path for handling ACCT instructions, in accordance with some implementations.

FIG. 5 is a block diagram of an example ACCB data path for handling ACCB instructions, in accordance with some implementations.

FIG. 6 is a flow diagram of an example method for performing one or more computations using ACCT and ACCB instructions, in accordance with some implementations.

FIG. 7 is a block diagram of an ACCT data path including a second vector register, in accordance with implementations.

FIG. 8 is a block diagram of an ACCB data path including a second vector register, in accordance with implementations.

FIG. 9 is a block diagram of an example subtract accumulate top (SUBACCT) data path for handling one or more SUBACCT instructions, in accordance with some implementations.

FIG. 10 is a block diagram of an example subtract accumulate bottom (SUBACCB) data path for handling one or more SUBACCB instructions, in accordance with some implementations.

### DETAILED DESCRIPTION

To increase the security of a processing system, some processors include processor cores configured to encrypt and decrypt data in the processing system based on one or more cryptographic algorithms (e.g., Rivest-Shamir-Adleman (RSA) algorithms, digital signal algorithms (DSAs)). Such cryptographic algorithms, for example, require the processor cores of the processor to perform computations on large integers (e.g., 256-bit integers, 512-bit integers, 4096-bit integers, or more) such as modular exponentiation. To this end, many processors split large number integers into blocks (e.g., equally sized blocks) and implement scalar arithmetic to perform computations on the blocks. For example, many processors split one or more 512-bit integers each into eight 64-bit blocks and perform scalar arithmetic computations (e.g., addition, subtraction) on each 64-bit block to determine a result. However, using scalar arithmetic to perform computations on the blocks requires a separate instruction for each block of the large number integer, increasing the processing time and lowering the processing efficiency of the system while each instruction is executed. As an example, to add two 512-bit integers each split into eight 64-bit blocks, a processor configured to execute x86 instruction sets (e.g., instruction sets defined by the x86 instruction set architecture (ISA)) uses one more or more libraries (e.g., GNU multiple precision arithmetic library (GMP)) including one or more add instructions (e.g., x86 instructions) and one or more add with carry (ADC) instructions (e.g., x86 instructions). Using such libraries, a processor is configured to add two 512-bit integers each split into eight 64-bit blocks by performing an add instruction and seven add with carry (ADC) instructions on the blocks of the 512-bit integers. During the add instruction, the processor is configured to add the least-significant 64-bit blocks of the 512-bit integers and set one or more carry flags (e.g., data indicating a value is to be carried to the next-significant 64-block bit) based on the sum of the least-significant 64-bit blocks of the 512-bit integers. During a next ADC instruction, the processor is configured to add the second least-significant 64-bit blocks of the 512-bit integers and one or more of the set carry flags. After performing six more ADC instructions, the processor is configured to produce a result in eight 64-bit numbers and a carry flag. By adding the two 512-bit integers in this way, the processor is required to execute eight instructions (e.g., one add instruction and seven ADC instructions), one for each 64-bit block of the 512-bit integers, before producing the result.

Alternatively, some processors split large number integers (e.g., 256-bit integers, 512-bit integers, 4096-bit integers) into equally sized blocks and implement vector arithmetic to perform computations (e.g., addition, subtraction) on the blocks. For example, a processor configured to execute Advanced Reduced Instruction Set Computer (RISC) Machines (ARM) instruction sets (e.g., instruction sets defined by an ARM ISA) uses one or more extensions (e.g., Scalable Vector Extension (SVE) 2) to perform computation on the blocks. Such extensions, for example, include one or more add-with-carry top (ADCLT) instructions (e.g., ARM instructions) and one or more add-with-carry bottom (ADCLB) instructions. During both the ADCLT and ADCLB instructions, the processor is configured to accumulate (e.g., add) a portion (e.g., half) of an operand (e.g., a top half in ADCLT and bottom half in ADCLB) into an accumulator (e.g., a top accumulator for ADCLT and a bottom accumulator for ADCLB) along with a carry-in vector to produce a sum and a carry-out result (e.g., data indicating a value is to be carried to the next lane of the accumulator). The processor then updates the bottom lanes of the accumulator with the sum and, based on the carry-out result, sets the least-significant bits of the top lanes of the accumulator to 0 or 1 while leaving other bits as 0. By accumulating the operands in this way, each subsequent accumulation must include the carry-out results produced from each previous accumulation, increasing the number of instructions needed to perform the computations. As an example, requiring that each subsequent accumulation must include the carry-out results produced from each previous accumulation increases the number of add instructions required for the top lanes of the accumulator during each accumulation which increases the total number of instructions needed. Additionally, in implementations, after all the accumulations for an operation are performed, a processor needs to execute additional instructions to merge the top and bottom accumulators into a single result, again increasing the number of instructions required and lowering the processing speed and efficiency of the processing system.

To this end, systems and techniques herein are directed to increasing processing speed and efficiency in a processing system using vector arithmetic by reducing the number of instructions needed to perform computations (e.g., modular exponentiation) on large number integers (e.g., 256-bit integers, 512-bit integers, 4096-bit integers, or more). For example, to perform operations on large number integers using vector arithmetic, a processor of a processing system is first configured to divide a large number integer into one or more blocks (e.g., one or more equally sized blocks) each having y-bits (e.g., having a y number of bits). Each block is then divided into two portions (e.g., equally sized portions) each having x-bits (e.g., having an x number of bits) and each portion is stored in a respective lane of a vector register. For example, a first portion (e.g., top portion) of each block storing the most significant bits of the block is stored in a respective lane of a vector register and a second portion (e.g., bottom portion) storing the least significant bits of each block is stored in another respective lane of a vector register.

The processor is then configured to perform one or more accumulate top (ACCT) instructions (e.g., ARM instructions) and one or more accumulate bottom (ACCB) instructions (e.g, ARM instructions) using the large number integer stored across the vector register in order to perform the computation (e.g., modular exponentiation).

To support the ACCT and ACCB instructions, the processor includes an ACCT data path supporting the ACCT instructions and an ACCB data path supporting the ACCB instructions. Both the ACCT and ACCB data paths each include, for example, a respective accumulator (e.g., top accumulator for ACCT, bottom accumulator for ACCB), one or more adders, and one or more vector registers storing a large number integer (e.g., storing operands indicating the portions of the blocks of the large number integer). The accumulators (e.g., top accumulator, bottom accumulator) in the ACCT and ACCB data paths each include vector registers with multiple pairs of lanes (e.g., multiple sets of lanes). Each pair of lanes include a first (e.g., top) lane configured to store the most significant bits of data stored in a pair of lanes and a second (e.g., bottom) lane configured to the least significant bits of data stored in the pair of lanes. During an ACCT instruction, the adders add each portion of a block representing the most significant bits of a block (e.g., top portion) as indicated in a lane of a vector register to a bottom lane of a respective pair of lanes of the accumulator. Based on the sum of the top portion of the block and data stored in the bottom lane of the pair of lanes, an adder is configured to generate a carry-out bit representing a bit to be carried to the top lane of the pair of lanes of the accumulator. For example, in response to the sum of the top portion of the block and data stored in the bottom lane of the pair of lanes being equal to or exceeding a predetermined threshold value, an adder is configured to generate a carry-out bit. Additionally, after generating the carry-out bit, an adder is configured to provide the carry-out bit to a second adder such that the second adder adds the carry-out bit to the top lane of the pair of lanes. An ACCT instruction is complete when the top portion of each block of the large number integer is added to a bottom lane of a respective pair of lanes of the accumulator and each carry-out bit is added to a top lane of a respective pair of lanes of the accumulator.

During an ACCB instruction, adders add each portion of a block representing the least significant bits of the block (e.g., bottom portion) as indicated by a respective lane of a vector register to a bottom lane of a respective pair of lanes of the accumulator. Based on the sum of the bottom portion of the block and data stored in the bottom lane of the pair of lanes, an adder is configured to generate a carry-out bit representing a bit to be carried to the top lane of the pair of lanes. For example, in response to the sum of the bottom portion of the block and data stored in the bottom lane of the pair of lanes being equal to or exceeding a predetermined threshold value, an adder generates the carry-out bit. Additionally, once the carry-out bit is generated, the adder provides the carry-out bit to a second adder such that the second adder adds the carry-out bit to the top lane of the pair of lanes. An ACCB instruction is complete when the bottom portion of each block of the large number integer is added to a bottom lane of a respective pair of lanes of the accumulator and each carry-out bit is added to a top lane of a respective pair of lanes of the accumulator. After the processor completes the ACCT and ACCB instructions for the large number integer, the top accumulator is added to the bottom accumulator to produce the result of the computation (e.g., modular exponentiation). For example, the processor first aligns the top accumulator and then adds the top accumulator to the bottom accumulator to produce the result of the computation. In this way, the processor generates the results of the computation using only two instructions (e.g., an ACCT instruction and an ACCB instruction) to produce the result, reducing the number of instructions needed to produce the result when compared to other arithmetic methods (e.g., x86 scalar arithmetic, ARM SVE2 vector arithmetic). Because the number of operations needed to produce the result is reduced, the processing time of the processing system is reduced and the processing efficiency of the processing system is increased.

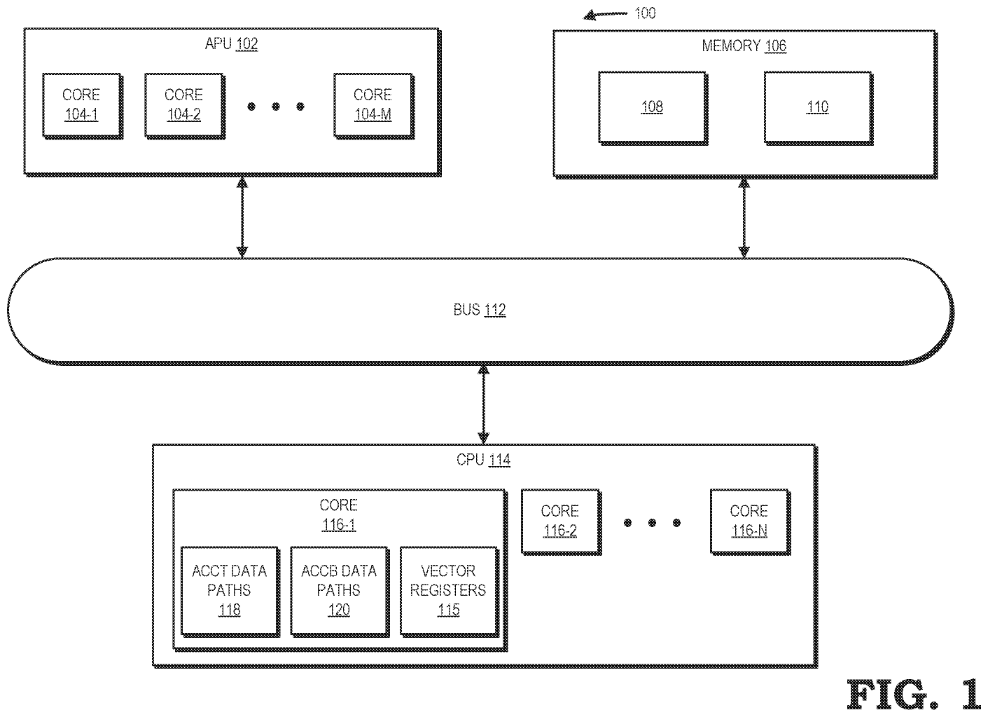

FIG. 1 is a processing system 100 implementing accumulate top (ACCT) and accumulate bottom (ACCB) instructions for integer addition, according to some implementations. In implementations, processing system 100 is configured to execute one or more applications (e.g., encryption applications, machine-learning applications, artificial intelligence (AI) applications, deep learning applications, shader applications, data center applications, cloud computing applications). To support the execution of such applications, the processing system 100 includes or has access to memory 106 or other storage component implemented using a non-transitory computer-readable medium, for example, a dynamic random-access memory (DRAM). However, in implementations, memory 106 is implemented using other types of memory including, for example, static random-access memory (SRAM), double data rate SDRAM (DDR SRAM), nonvolatile RAM, and the like. According to implementations, memory 106 includes an external memory implemented external to the processing units implemented in the processing system 100. The processing system 100 also includes a bus 112 to support communication between entities implemented in the processing system 100, such as the memory 106, accelerated processing unit (APU) 102, central processing unit (CPU) 114, or any combination thereof.

In implementations, memory 106 includes program code 110 for one or more applications executed by processing system 100. Such program code 110, for example, includes data indicating one or more workloads, instructions, operations, or any combination thereof to be performed for one or more applications. Additionally, memory 106 is configured to store an operating system 108 to support the execution of instructions for the applications. Operating system 108, for example, includes data (e.g., program code) indicating one or more operations, instructions, or both to support the execution of applications by processing system 100. These operations and instructions include, for example, scheduling tasks (e.g., workloads, instructions) for one or more applications, allocating resources (e.g., registers, local data shares, scratch memory) to tasks for one or more applications, or both. According to implementations, operating system 108 is associated with an instruction set architecture (ISA). Such an ISA, for example, includes a model indicating the instructions, data types, registers, memory management, virtual memory management, I/O models, or any combination thereof supported by operating system 108, CPU 114, or both. For example, operating system 108 includes and issues instructions based on a certain ISA (e.g., Advanced RISC Machines (ARM)). As another example, CPU 114 includes an architecture configured to support instructions based on a certain ISA (e.g., ARM).

CPU 114 includes, for example, any of a variety of parallel processors, vector processors, coprocessors, non-scalar processors, highly parallel processors, artificial intelligence (AI) processors, inference engines, machine learning processors, other multithreaded processing units, scalar processors, serial processors, or any combination thereof. According to implementations, CPU 114 is configured to receive one or more instructions from program code 110 and is configured to perform the received instructions. To this end, CPU 114 includes one or more processor cores 116 each configured to perform one or more operations for the received instructions. For example, CPU 114 includes one or more processor cores 116 that each operate as a compute unit. These compute units each include one or more single instruction, multiple data (SIMD) units that perform the same operation on different data sets to produce one or more results. Such results, for example, include data resulting from the performance of one or more operations by one or more processor cores 116. After producing one or more results, a compute unit is then configured to store the results in a cache within or otherwise coupled to the compute unit (e.g., the processor core 116 operating as a compute unit), memory 106, or both. Though the example implementation presented in FIG. 1 presents CPU 114 as having three processor cores (116-1, 116-2, 116-N) representing an N number of processor cores, in other implementations, CPU 114 may have any number of processor cores 116.

To help increase the security of processing system 100, CPU 114 is configured to encrypt and decrypt data stored in and read out of memory 106. For example, CPU 114 is configured to encrypt one or more results (e.g., data resulting from the performance of one or more instructions, operations, or both) before the results are stored in memory 106. As another example, CPU 114 is configured to decrypt data stored in memory 106 when the data is read out of memory 106. To this end, CPU 114 is configured to encrypt and decrypt data using one or more cryptographic algorithms (e.g., Rivest-Shamir-Adleman (RSA) algorithms, digital signal algorithms (DSAs)). That is to say, CPU 114 is configured to perform instructions from an application, operating system 108, or both to encrypt and decrypt data using one or more cryptographic algorithms. According to implementations, to encrypt and decrypt data according to one or more cryptographic algorithms, CPU 114 is configured to perform one or more computations (e.g., modular exponentiation) on one or more large number integers (e.g., 512-bit integers, 4096-bit integers, or more). For example, to encrypt and decrypt data according to an RSA algorithm, CPU 114 is configured to perform modular exponentiation on one or more large number integers.

To facilitate the performance of one or more computations on one or more large number integers, one or more processor cores 116 of CPU 114 each include one or more vector registers 115. In implementations, one or more vector registers 115 are configured to store data indicating one or more large number integers used for one or more computations as one or more operands. For example, one or vector registers 115 are configured to store one or more register operands (e.g., data referring to a large number integer stored in a register), memory operands (e.g., data referring to a large number integer stored in a memory), or both that indicate a large number integer. In implementations, each vector register 115 includes two or more lanes each configured to store data. To store data indicating a large number integer in a vector register 115, CPU 114 (e.g., one or more processor cores 116 of CPU 114) is first configured to divide a large number integer into two or more blocks (e.g., equally sized blocks) each having a y-number of bits and each representing a distinct and different portion of the large number integer. For example, CPU 114 is configured to divide a 512-bit large number integer into eight blocks each having 64 bits and each representing a distinct and different portion of the 512-bit large number integer. CPU 114 is then configured to store data indicating each block into a respective set (e.g. pair) of lanes of a vector register 115 of a processor core 116. To this end, CPU 114 (e.g., one or more processor cores 116 of CPU 114) is configured to further divide each block having an y-number of bits into a first (e.g., top) portion having an x-number of bits and including the most significant bits of the block and a second (e.g., bottom) portion having an x-number of bits and including the least significant bits of the block. The CPU 114 is configured to then store data (e.g., register operand, memory operand) indicating the first portion including the most significant bits of the block in a first (e.g., top) lane of a set (e.g., pair) of lanes in the vector register 115 and data indicating the second portion including the least significant bits of the block in a second (e.g., bottom) lane of the set (e.g., pair) of lanes of the vector register 115. In this way, the vector register 115 stores data indicating a large number integer by having one or more lanes of the vector register 115 each include data (e.g., operands) indicating x-bit portions (e.g., portions having an x-number of bits) of the y-bit blocks (e.g., blocks having a y-number of bits) that make up the large number integer.

Further, to perform one or more computations on one or more large number integers indicated by vector registers 115, one or more processor cores 116 of CPU 114 are configured to perform one or more ACCT instructions (e.g., ARM instructions), one or more ACCB instructions (e.g., ARM instructions), or both. For example, to perform a modular exponentiation on a large number integer indicated by a vector register 115 of a processor core 116, the processor core 116 is configured to perform an ACCT instruction and an ACCB instruction. To perform such ACCT and ACCB instructions, one or more processor cores 116 of CPU 114 each include one or more ACCT data paths 118 and one or more ACCB data paths 120 that each include, for example, a respective accumulator (e.g., a top accumulator for ACCT data path 118 and a bottom accumulator for ACCB data path 120), one or more adders, one or more vector registers 115, or any combination thereof. The accumulators (e.g., top accumulator, bottom accumulator) in ACCT data paths 118 and ACCB data paths 120 each include vector registers 115 with multiple sets (e.g., pairs) of lanes. Each set (e.g., pair) of lanes include a first (e.g., top) lane configured to store the most significant bits of data stored in a set of lanes and a second (e.g., bottom) lane configured to the least significant bits of data stored in the set of lanes. During an ACCT instruction, one or more processor cores 116 of CPU 114 are configured to add each portion (e.g., top portions) including the most significant bits of a block of a large number integer indicated in a vector register 115 to a bottom lane of a respective set of lanes in a top accumulator (e.g., formed by a respective vector register 115). Similarly, during an ACCB instruction, one or more processor cores 116 of CPU 114 are configured to add each portion (e.g., bottom portions) including the least significant bits of a block of a large number integer indicated in a vector register 115 to a bottom lane of a respective set of lanes in a bottom accumulator (e.g., formed by a respective vector register 115)

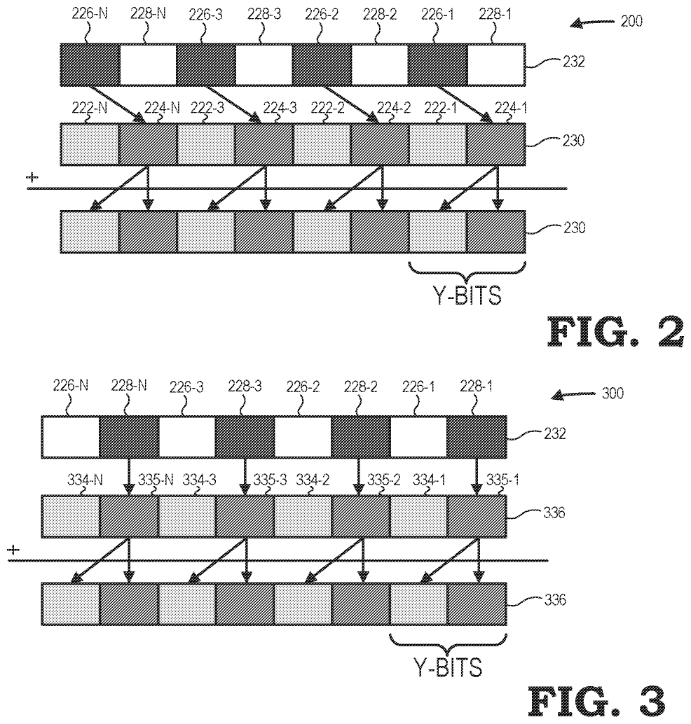

For example, referring to the example ACCT instruction 200 indicated in FIG. 2, a top accumulator 230 (e.g., formed by a vector register 115) includes lanes 222-1, 224-1, 222-2, 224-2, 222-3, 224-3, 222-N, 224-N grouped into pairs. For example, each pair of lanes of top accumulator 230 includes a first (e.g., top) lane 222 (e.g., indicated by light grey shading in FIG. 2) and a second (e.g., bottom) lane 224 (e.g., indicated by the medium grey shading in FIG. 2). Though the example implementation in FIG. 2 shows top accumulator 230 as having four pairs of lanes (222-1, 224-1; 222-2, 224-2; 222-3, 224-3; 222-N, 224-N) representing an N number of pairs of lanes, in other implementations, top accumulator 230 can include any number of pairs of lanes. Likewise, in ACCT instruction 200, a vector register 232, similar to or the same as vector register 115, is configured to store data indicating a large number integer and includes lanes 226-1, 228-1, 226-2, 228-2, 226-3, 228-3, 226-N, 228-N grouped into pairs. As an example, each pair of lanes of vector register 115 are configured to store data indicating a respective block of a large number integer (e.g., a block having a y-number of bits). Additionally, each pair of lanes of vector register 232 includes a first (e.g., top) lane 226 (e.g., indicated by dark grey shading in FIG. 2) that stores data indicating a portion (e.g., top portion) of the block including the most significant bits of the block and a second (e.g., bottom) lane 228 (e.g., indicated by no shading in FIG. 2) that stores data indicating a portion (e.g., bottom portion) of the block including the least significant bits of the block. Though the example implementation in FIG. 2 shows vector register 232 having four pairs of lanes (226-1, 228-1; 226-2, 228-2; 226-3, 228-3; 226-N, 228-N) representing an N number of pairs of lanes, in other implementations, vector register 232 can include any number of pairs of lanes.

During ACCT instruction 200, CPU 114 (e.g., one or more processor cores 116 of CPU 114) adds each top portion of a block (e.g., the portion including data indicating the most significant bits of a block) represented by a respective top lane 226 of vector register 232 to a bottom lane 224 of a respective pair of lanes of top accumulator 230. For example, CPU 114 adds the top portion of a block represented by top lane 226-1 to bottom lane 224-1, the top portion of a block represented by top lane 226-2 to bottom lane 224-2, the top portion of a block represented by top lane 226-3 to bottom lane 224-3, and the top portion of a block represented by top lane 226-N to bottom lane 224-N. In other words, CPU 114 is configured to add each top portion of a block represented by a respective top lane 226 of vector register 232 to data stored in a bottom lane 224 of a respective pair of lanes of top accumulator 230 and store the respective sum of the top portion of a block and the data stored in a bottom lane 224 in the bottom lane 224. Additionally, based on the sum of the top portion of a block and the data stored in a bottom lane 224, CPU 114 is configured to generate a carry-out bit (e.g., data indicating a bit is to be carried to the top lane 222 of top accumulator 230). For example, if the sum of the top portion of a block and the data stored in a bottom lane 224 is equal to or exceeds a predetermined threshold value, CPU 114 generates a carry-out bit. In response to generating the carry-out bit, CPU 114 is configured to add the carry-out bit to a top lane 222 of a respective pair of lanes (e.g., the pair of lanes including the bottom lane 224 associated with the carry-out bit). As such, the bottom lane 224 of a pair of lanes stores the sum of the top portion of a block and the data stored in a bottom lane 224 and a top lane 222 of a pair of lanes stores a sum of a carry-out bit and the data stored in the top lane 222. In implementations, ACCT instruction 200 is completed when CPU 114 adds the top portion of each block, represented by respective top lanes 226, to a bottom lane 224 of a respective pair of lanes of top accumulator 230 and CPU 114 adds each carry-out bit to a top lane 222 of the respective pair of lanes of top accumulator 230.

Referring to the example ACCB instruction 300 indicated in FIG. 3, a bottom accumulator 336 (e.g., formed by a vector register 115) includes lanes 334-1, 335-1, 334-2, 335-2, 334-3, 335-3, 334-N, 335-N grouped into pairs. For example, each pair of lanes of bottom accumulator 336 includes a first (e.g., top) lane 334 (e.g., indicated by light grey shading in FIG. 3) and a second (e.g., bottom) lane 335 (e.g., indicated by the medium grey shading in FIG. 3). Though the example implementation in FIG. 3 shows bottom accumulator 336 as having four pairs of lanes (334-1, 335-1; 334-2, 335-2; 334-3, 335-3; 334-N, 335-N) representing an N number of pairs of lanes, in other implementations, bottom accumulator 336 can include any number of pairs of lanes. Additionally, in ACCB instruction 300, vector register 232 is configured to store data indicating a large number integer and includes lanes 226-1, 228-1, 226-2, 228-2, 226-3, 228-3, 226-N, 228-N grouped into pairs. Each pair of lanes of vector register 232 includes a first (e.g., top) lane 226 (e.g., indicated by no shading in FIG. 3) that stores data indicating a portion (e.g., top portion) of the block including the most significant bits of the block and a second (e.g., bottom) lane 228 (e.g., indicated by dark grey shading in FIG. 3) that stores data indicating a portion (e.g., bottom portion) of the block including the least significant bits of the block. Though the example implementation in FIG. 3 shows vector register 232 having four pairs of lanes (226-1, 228-1; 226-2, 228-2; 226-3, 228-3; 226-N, 228-N) representing an N number of pairs of lanes, in other implementations, vector register 232 can include any number of pairs of lanes.

During ACCB instruction 300, CPU 114 (e.g., one or more processor cores 116 of CPU 114) adds each bottom portion of a block (e.g., the portion including data indicating the least significant bits of a block) represented by a respective bottom lane 228 of vector register 232 to a bottom lane 335 of a respective pair of lanes of bottom accumulator 336. For example, CPU 114 adds the bottom portion of a block represented by bottom lane 228-1 to bottom lane 335-1, the bottom portion of a block represented by bottom lane 228-2 to bottom lane 335-2, the bottom portion of a block represented by bottom lane 228-3 to bottom lane 335-3, and the bottom portion of a block represented by bottom lane 228-N to bottom lane 335-N. In other words, CPU 114 is configured to add each bottom portion of a block represented by a respective bottom lane 228 of vector register 232 to data stored in a bottom lane 335 of a respective pair of lanes of bottom accumulator 336 and store the respective sum of the bottom portion of a block and the data stored in a bottom lane 335 in the bottom lane 335. Further, based on the sum of the bottom portion of a block and the data stored in a bottom lane 335, CPU 114 is configured to generate a carry-out bit (e.g., data indicating a bit is to be carried to the top lane 334 of bottom accumulator 336). For example, if the sum of the bottom portion of a block and the data stored in a bottom lane 335 is equal to or exceeds a predetermined threshold value, CPU 114 generates a carry-out bit. In response to generating the carry out-bit, CPU 114 is configured to add the carry-out bit to a top lane 334 of a respective pair of lanes (e.g., the pair of lanes including the bottom lane 335 associated with the carry-out bit). In this way, the bottom lane 335 of a pair of lanes stores the sum of the bottom portion of a block and the data stored in a bottom lane 335 and a top lane 334 of a pair of lanes stores a sum of a carry-out bit and the data stored in the top lane 334. According to implementations, ACCB instruction 300 is completed when CPU 114 adds the bottom portion of each block, represented by respective bottom lanes 228, to a bottom lane 335 of a respective pair of lanes of bottom accumulator 336 and CPU 114 adds each carry-out bit to a top lane 334 of the respective pair of lanes of bottom accumulator 336.

Referring again to FIG. 1, after CPU 114 (e.g., one or more processor cores 116 of CPU 114) has completed an ACCT instruction and an ACCB instruction for one or more large number integers, CPU 114 is configured to add the top accumulator 230 of the ACCT instruction to the bottom accumulator 336 of the ACCB instruction to produce the result of the computation for the one or more large integer numbers. To this end, in some implementations, CPU 114 is configured to align top accumulator 230, bottom accumulator 336, or both, such that the data in top accumulator 230 is able to be added to the data in bottom accumulator 336. For example, in response to CPU 114 completing an ACCT instruction and ACCB instruction for a large number integer, CPU 114 is configured to align top accumulator 230 such that data from top accumulator 230 is able to be added to bottom accumulator 336. CPU 114 then adds the data from top accumulator 230 to bottom accumulator 336 to produce a result of the computation. Such a result, for example, includes a large number integer resulting from the performance of a computation. By determining the result by only performing an ACCT instruction and ACCB instruction on a large number integer and adding the resulting accumulators 230, 336 together, CPU 114 only requires two instructions (ACCT, ACCB) per large number integer to produce such a result. As such, CPU 114 performs less instructions to perform these computations than in other arithmetic methods (e.g., x86 scalar arithmetic, ARM SVE2 arithmetic), reducing the processing time and increasing the processing efficiency of processing system 100.

According to some implementations, processing system 100 also includes an APU 102 that is connected to the bus 112 and therefore communicates with the CPU 114 and the memory 106 via the bus 112. APU 102 includes, for example, any of a variety of parallel processors, vector processors, coprocessors, graphics processing units (GPUs), general-purpose GPUs (GPGPUs), non-scalar processors, highly parallel processors, AI processors, inference engines, machine learning processors, other multithreaded processing units, scalar processors, serial processors, or any combination thereof. To this end, APU 102 implements a plurality of processor cores 104-1 to 104-N that execute instructions concurrently or in parallel. In implementations, one or more of the processor cores 104 each operate as one or more compute units (e.g., SIMD units) that perform the same operation on different data sets. Though in the example implementation illustrated in FIG. 1, three processor cores (104-1, 104-2, 104-M) are presented representing an M number of cores, the number of processor cores 104 implemented in APU 102 is a matter of design choice. As such, in other implementations, APU 102 can include any number of processor cores 104. The processor cores 104 execute instructions such as program code 110 (e.g., a shader program) stored in memory 106, and APU 102 stores information in memory 106 such as the results of the executed instructions (e.g., instructions from a shader program).

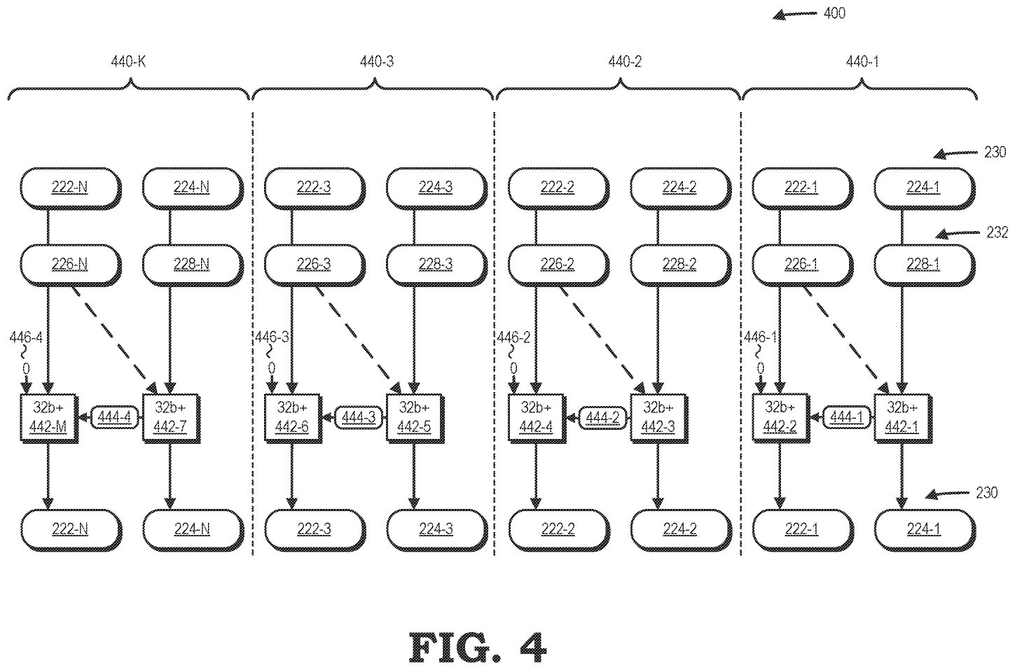

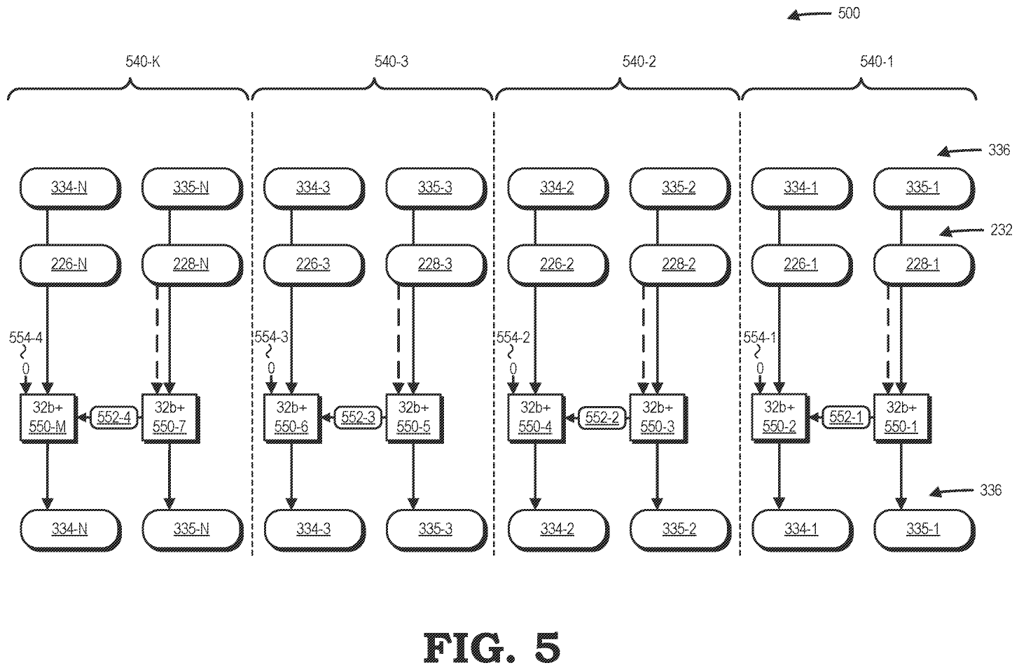

Referring now to FIG. 4, an example ACCT data path 400 for handling ACCT instructions similar to or the same as ACCT instruction 200 is presented. According to implementations, ACCT data path 400 is configured to handle an ACCT instruction for one or more large number integers. As an example, in the implementation presented in FIG. 4, ACCT data path 400 is configured to handle an ACCT instruction for a 256-bit integer. Though the example implementation presented in FIG. 4 presents ACCT data path 400 handling an ACCT instruction for a 256-bit integer, in other implementations, ACCT data path 400 is configured to handle an ACCT instruction for any sized large number integer (e.g., 512-bit, 4096-bit). To handle an ACCT instruction, ACCT data path 400 is divided into two or more sections 440 each associated with a respective y-bit block (e.g., block having a y-number of bits) of a large number integer. For example, section 440-1 is associated with a block (e.g., 64-bit block) having the least significant bits of the large number integer, section 440-2 is associated with a block (e.g., 64-bit block) having the next least significant bits of the large number integer, section 443-3 is associated with a block (e.g., 64-bit block) having the third least significant bits of the large number integer, and section 440-K is associated with a block (e.g., 64-bit block) having the most significant bits of the large number integer. Though the example implementation in FIG. 5 presents ACCT data path 400 as having four sections (440-1, 440-2, 440-3, 440-K) representing a K number of sections, in other implementations, ACCT data path 400 can have any number of sections 440.

In implementations, ACCT data path 400 includes top accumulator 230 having lanes 222-1, 224-1, 222-2, 224-2, 222-3, 224-3, 222-N, and 224-N and vector register 232 having lanes 226-1, 228-1, 226-2, 228-2, 226-3, 228-3, 226-N, and 228-N. Each section 440 of ACCT data path 400 includes a respective pair of lanes from top accumulator 230 and vector register 232. For example, each section 440 includes a pair of lanes from top accumulator 230 that includes a respective top lane 222 and a respective bottom lane 224. As an example, section 440-1 includes top lane 222-1 and bottom lane 224-1 from top accumulator 230. Additionally, each section 440 includes a pair of lanes from vector register 232 that store data (e.g., register operands, memory operands) indicating the block associated with the section 440. For example, section 440-1 is associated with a block including the least significant bits of the large number integer. Further, section 440-1 includes a pair of lanes (e.g., 226-1, 228-1) from vector register 232 that stores data indicating the block including the least significant bits of the large number integer. As an example, within such a pair of lanes, a first (e.g., top) lane 226-1 stores data (e.g., register operand, memory operand) indicating a first (e.g., top) portion of the block associated with section 440-1 that stores the most significant bits of the block and a second (e.g., bottom) lane 228-1 stores data (e.g., register operand, memory operand) indicating a second portion of the block including the least significant bits of the block.

In implementations, each section 440 of ACCT data path 400 also includes two or more adders 442. For example, in the example implementation of FIG. 4, ACCT data path 400 is configured to perform an ACCT instruction for a 256-bit integer. To this end, each section 440 includes two or more respective 32-bit adders 442 to perform additions for a 64-bit block of the 256-bit integer. As an example, a section 440-1 includes adders (e.g., 32-bit adders) 442-1 and 442-2, section 440-2 includes adders 442-3 and 442-4, section 440-3 includes adders 442-5 and 442-6, and section 440-K includes adders 442-7 and 442-M. Though the example implementation of FIG. 4 presents ACCT data path 400 as including eight adders (442-1, 442-2, 442-3, 442-4, 442-5, 442-6, 442-7, 442-M) representing an M number of adders, in other implementations, ACCT data path 400 can include any number of adders 442.

When handling (e.g., performing) an ACCT instruction for a large number integer, each section 440 of ACCT data path 400 is configured to handle a respective block of the large number integer (e.g., the block associated with the section 440). To perform an ACCT instruction, data from the bottom lane 224 of top accumulator 230 within the section 440 and a top portion of the block (e.g., portion including the most significant bits of the block) as represented by the data (e.g., register operand, memory operand) in the top lane 226 of vector register 232 within the section 440 is provided to an adder 442. For example, within section 440-1, data from bottom lane 224-1 of top accumulator 230 and a top portion of the block as represented by the data (e.g., register operand, memory operand) in top lane 226-1 of vector register 232 are provided to adder 442-1. In response to receiving data from the bottom lane 224 of top accumulator 230 and a top portion of the block as represented by the data in the top lane 226 of vector register 232, an adder 442 is configured to add the data from the bottom lane 224 of top accumulator 230 and a top portion of the block together to produce a sum. Additionally, the adder 442 is configured to store such a sum in the bottom lane 224 of top accumulator 230 in the same section 440 as the adder 442. For example, within section 440-1, adder 442-1 is configured to store the sum of the data in bottom lane 224-1 of top accumulator 230 and a top portion of the block as represented by top lane 226-1 of vector register 232 in bottom lane 224-1 of top accumulator 230.

Additionally, in response to receiving data from the bottom lane 224 of top accumulator 230 and a top portion of the block as represented by the data in the top lane 226 of vector register 232, an adder 442 is configured to generate a respective carry-out bit 444 based on the sum of the data from the bottom lane 224 of top accumulator 230 and a top portion of the block. For example, in response to the sum of the data from the bottom lane 224 of top accumulator 230 and a top portion of the block being equal to or exceeding a predetermined threshold, an adder 442 is configured to generate a carry-out bit 444. Each carry-out bit 444, for example, indicates that a value (e.g., 1) is to be added to the top lane 222 of top accumulator 230 in the same section 440 as the adder 442. Referring to the example implementation in FIG. 4, carry-out bit 444-1 indicates a value (e.g., 1) is to be added to top lane 222-1 of top accumulator 230, carry-out bit 444-2 indicates a value is to be added to top lane 222-2 of top accumulator 230, carry-out bit 444-3 indicates a value is to be added to top lane 222-3 of top accumulator 230, and carry-out bit 444-4 indicates a value is to be added to top lane 222-N of top accumulator 230. To this end, each section 440 includes a second adder 442 configured to receive a carry-out bit 444 from a first adder 442 of the section 440 and data from the top lane 222 of top accumulator 230 in the section 440. As an example, within section 440-1, an adder 442-2 is configured to receive carry-out bit 444-1 from adder 442-1 and data from top lane 222-1 of top accumulator 230. Further, in some implementations, the second adder is configured to receive a zero bit 446, for example, to add to a received carry-out bit 444. Referring to the example implementation of FIG. 4, adder 442-2 receives zero bit 446-1, adder 442-4 receives zero bit 446-2, adder 442-6 received zero bit 446-3, and adder 442-M receives zero bit 446-4.

In response to receiving a carry-out bit 444, data from a top lane 222 of top accumulator 230, zero bit 446, or any combination thereof, an adder 442 is configured to produce a sum by adding the received carry-out bit 444, data from a top lane 222 of top accumulator 230, and zero bit 446 together. Additionally, the adder 442 is configured to store such a sum in the top lane 222 of top accumulator 230 in the same section 440 as the adder. For example, within section 440-1, adder 442-2 is configured to store a sum of carry-out bit 444-1, data from top lane 222-1 of top accumulator 230, and zero bit 446-1 in top lane 222-1. As such, after the ACCT instruction is completed, each bottom lane 224 of top accumulator 230 within a section 440 includes a sum of a top portion (e.g., a portion including the most significant bits) of the block associated with the section 440 and the data in the bottom lane 224 of top accumulator 230 within section 440.

Additionally, each top lane 222 of top accumulator 230 within a section 440 includes a sum of a carry-out bit and the data in the top lane 222 of top accumulator 230 within section 440, allowing the carry-out bits 444 to be carried throughout multiple accumulations.

Referring now to FIG. 5, an example ACCB data path 500 for handling ACCB instructions similar to or the same as ACCB instruction 300 is presented. In implementations, ACCB data path 500 is configured to handle an ACCB instruction for one or more large number integers (e.g., one or more large number integers on which an ACCT instruction was performed). As an example, in the implementation presented in FIG. 5, ACCB data path 500 is configured to handle an ACCT instruction for a 256-bit integer. Though the example implementation presented in FIG. 5 presents ACCB data path 500 handling an ACCB instruction for a 256-bit integer, in other implementations, ACCB data path 500 is configured to handle an ACCB instruction for any sized large number integer (e.g., 512-bit, 4096-bit). According to implementations, ACCB data path 500 is divided into two or more sections 540 each associated with a respective y-bit block of a large number integer. In some implementations, each section 540 of ACCB data path 500 is associated with a same block as a section 440 of ACCT data path 400. Referring to the example implementations presented in FIGS. 4 and 5, sections 440-1 and 540-1 are both associated with a block (e.g., 64-bit block) having the least significant bits of the large number integer, sections 440-2 and 540-2 are both associated with a block (e.g., 64-bit block) having the next least significant bits of the large number integer, sections 440-3 and 540-3 are both associated with a block (e.g., 64-bit block) having the third least significant bits of the large number integer, and sections 440-K and 540-K are both associated with a block (e.g., 64-bit block) having the most significant bits of the large number integer. Though the example implementation in FIG. 5 presents ACCB data path 500 as having four sections (540-1, 540-2, 540-3, 540-K) representing a K number of sections, in other implementations, ACCB data path 500 can have any number of sections 540.

In implementations, ACCB data path 500 includes bottom accumulator 336 having lanes 334-1, 335-1, 334-2, 335-2, 334-3, 335-3, 334-N, and 335-N, and vector register 232 having lanes 226-1, 228-1, 226-2, 228-2, 226-3, 228-3, 226-N, and 228-N. Each section 540 of ACCB data path 500 includes a respective pair of lanes (e.g., top lane 334 and bottom lane 335) from bottom accumulator 336 and a respective pair of lanes (e.g., top lane 226 and bottom lane 228) from vector register 232. As an example, section 540-1 includes top lane 334-1 and bottom lane 335-1 from bottom accumulator 336. Additionally, each section 540 includes the pair of lanes from vector register 232 that store data indicating the block associated with the section 540. For example, section 540-K is associated with a block including the most significant bits of the large number integer. Further, section 540-K includes a pair of lanes (e.g., 226-N, 228-N) from vector register 232 that stores data indicating the block including the most significant bits of the large number integer. As an example, within such a pair of lanes, a first (e.g., top) lane 226-N stores data (e.g., register operand, memory operand) indicating a first (e.g., top) portion of the block associated with section 540-1 that stores the most significant bits of the block and a second (e.g., bottom) lane 228-N that stores data (e.g., register operand, memory operand) indicating a second portion of the block including the least significant bits of the block.

Each section 540 of ACCB data path 500 also includes two or more adders 550. For example, in the example implementation of FIG. 5, ACCB data path 500 is configured to perform an ACCB instruction for a 256-bit integer. To this end, each section 540 includes two or more respective 32-bit adders 550 to perform additions for a 64-bit block of the 256-bit integer. As an example, section 540-1 includes adders (e.g., 32-bit adders) 550-1 and 550-2, section 540-2 includes adders 550-3 and 550-4, section 540-3 includes adders 550-5 and 550-6, and section 540-K includes adders 550-7 and 550-M. Though the example implementation of FIG. 5 presents ACCB data path 500 as including seven adders (550-1, 550-2, 550-3, 550-4, 550-5, 550-6, 550-7, 550-M) representing an M number of adders, in other implementations, ACCB data path 500 can include any number of adders 550.

To handle an ACCB instruction for a large number integer, each section 540 of ACCB data path 500 is configured to handle a respective block of the large number integer (e.g., the block associated with the section 540). To this end, ACCB data path 500 provides data from the bottom lane 335 of bottom accumulator 336 within a section 540 and a bottom portion of the block (e.g., portion including the least significant bits of the block) as represented by the data (e.g., register operand, memory operand) in the bottom lane 228 of vector register 232 within the section 540 to an adder 550. For example, within section 540-K, data from bottom lane 335-N of bottom accumulator 336 and a bottom portion of the block as represented by the data (e.g., register operand, memory operand) in bottom lane 228-N of vector register 232 are provided to adder 550-7. In response to receiving data from a bottom lane 335 of bottom accumulator 336 and a bottom portion of the block as represented by the data in a bottom lane 335 of vector register 232, an adder 550 is configured to add the data from the bottom lane 335 of bottom accumulator 336 and a bottom portion of the block together to produce a sum. Additionally, the adder 550 is configured to store such a sum in the bottom lane 335 of bottom accumulator 336 in the same section 540 as the adder 550. For example, within section 540-K, adder 550-7 is configured to store the sum of the data in bottom lane 335-N of bottom accumulator 336 and a bottom portion of the block as represented by bottom lane 228-N of vector register 232 in bottom lane 335-N of bottom accumulator 336.

Further, in response to receiving data from a bottom lane 335 of bottom accumulator 336 and a bottom portion of the block as represented by the data in a bottom lane 228 of vector register 232, an adder 550 is configured to generate a respective carry-out bit 552 based on the sum of the data from the bottom lane 335 of bottom accumulator 336 and the bottom portion of the block. For example, in response to the sum of the data from the bottom lane 335 of bottom accumulator 336 and a bottom portion of the block being equal to or exceeding a predetermined threshold, an adder 550 is configured to generate a carry-out bit 552. Each carry-out bit 552, for example, indicates that a value (e.g., 1) is to be added to the top lane 334 of bottom accumulator 336 in the same section 540 as the adder 550. Referring to the example implementation in FIG. 5, carry-out bit 552-1 indicates a value (e.g., 1) is to be added to top lane 334-1 of bottom accumulator 336, carry-out bit 552-2 indicates a value is to be added to top lane 334-2 of bottom accumulator 336, carry-out bit 552-3 indicates a value is to be added to top lane 334-3 of bottom accumulator 336, and carry-out bit 552-4 indicates a value is to be added to top lane 334-1 of bottom accumulator 336. To this end, each section 540 includes a second adder 550 configured to receive carry-out bit 552 from a first adder 550 of the section 540 and data from the top lane 334 of bottom accumulator 336 in the section 540. As an example, within section 540-K, an adder 550-M is configured to receive carry-out bit 552-4 from adder 550-7 and data from top lane 334-N of bottom accumulator 336. Additionally, in some implementations, the second adder 550 is configured to receive a zero bit 554, for example, to add to a received carry-out bit 552. Referring to the example implementation of FIG. 5, adder 550-2 receives zero bit 554-1, adder 550-4 receives zero bit 554-2, adder 550-6 receives zero bit 554-3, and adder 550-M receives zero bit 554-4.

In implementations, after receiving a carry-out bit 552, data from a top lane 334 of bottom accumulator 336, zero bit 554, or any combination thereof, an adder 550 is configured to produce a sum by adding the received carry-out bit 552, data from a top lane 334 of bottom accumulator 336, and zero bit 554 together. Further, the adder 550 is configured to store such a sum in the top lane 334 of bottom accumulator 336 in the same section 540 as the adder 550. For example, within section 540-K, adder 550-M is configured to store a sum of carry-out bit 552-4, data from top lane 334-N of bottom accumulator 336, and zero bit 554-4 in top lane 334-N. In this way, when the ACCB instruction is completed, each bottom lane 335 of bottom accumulator 336 within a section 540 includes a sum of a bottom portion (e.g., a portion including the least significant bits) of the block associated with the section 540 and the data in the bottom lane 335 of bottom accumulator 336 within section 540. Also, each top lane 334 of bottom accumulator 336 within a section 540 includes a sum of a carry-out bit 552 and the data in the top lane 334 of bottom accumulator 336 within section 540, allowing the carry-out bits 552 to be carried throughout multiple accumulations.

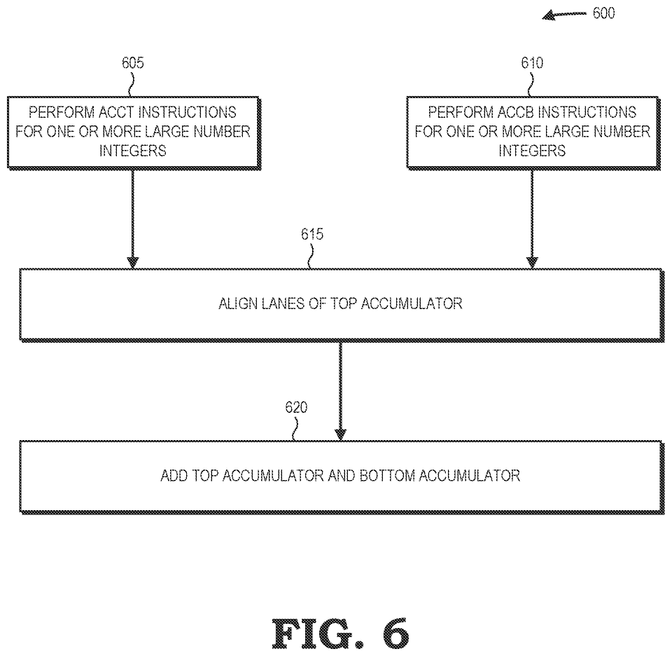

Referring now to FIG. 6, an example method 600 for performing one or more computations using ACCT and ACCB instructions is presented. At step 605 of example method 600, CPU 114 (e.g., one or more processor cores 116 of CPU 114) performs one or more ACCT operations for one or more large number integers (e.g., 256-bit integers, 512-bit integers, 4096-bit integers). To this end, for each large number integer, CPU 114 is configured to divide the large number integer (e.g., 256-bit integer, 512-bit integer, 4096-bit integer) into a plurality of blocks of data with each block of data having a same number of bits (e.g., a y-number of bits). CPU 114 then stores data (e.g., register operands, memory operands) indicating each block of data in a pair of lanes of vector register 232 with a first lane (e.g., top lane 226) of the pair of lanes storing data indicating a first portion (e.g., top portion) of the block of data and a second lane (e.g., bottom lane 228) of the pair of lanes storing data indicating a second portion (e.g., bottom portion) of the block of data. In implementations, the first portion of the block of data and the second portion of the block of data are different. For example, a first lane (e.g., top lane 226) of the pair of lanes stores data indicating a first portion (e.g., top portion) of the block of data including the most significant bits of the block of data and a second lane (e.g., bottom lane 228) of the pair of lanes stores data indicating a second portion (e.g., bottom portion) of the block of data including the least significant bits of the block of data.

Still referring to step 605, to perform an ACCT instruction for one or more large number integers, CPU 114 (e.g., one or more processor cores 116 of CPU 114) adds a first portion (e.g., top portion) of each block of data of the large number integers (e.g., as indicated by top lanes 226 of vector register 232) to data in a first lane (e.g., bottom lane 224) of a respective pair of lanes (e.g., top lane 222 and bottom lane 224) of a top accumulator 230. In implementations, for each block of data of a large number integer, CPU 114 adds a first portion of a block of data to data in a first lane of a pair of lanes of a first (e.g., top) accumulator 230 to produce a first sum (e.g., the sum of the first portion of the block of data and the data in the first lane of the pair of lanes) and a carry-out bit 444. According to implementations, CPU 114 is configured to generate a carry-out bit 444 based on the first sum (e.g., the sum of the first portion of the block of data and the data in the first lane of the pair of lanes). For example, in response to the first sum being equal to or exceeding a threshold value, CPU 114 generates a carry-out bit 444. Such a carry-out bit 444, for example, includes data indicating that a value (e.g., 1) is to be added to a second lane (e.g., top lane 222) of the pair of lanes of the top accumulator 230. As an example, after generating carry-out bit 444, CPU 114 adds carry-out bit to the data stored in the second lane (e.g., top lane 222) of the pair of lanes of the top accumulator 230. After CPU 114 has added a first portion (e.g., top portion) of each block of data of one or more large number integers to a first lane (e.g., bottom lane 224) of a respective pair of lanes of top accumulator 230 and added each generated carry-out bit 444 to a second lane (e.g., top lane 222) of a respective pair of lanes of top accumulator 230, CPU 114 completes the ACCT instruction.

At step 610, CPU 114 (e.g., one or more processor cores 116 of CPU 114) is configured to perform an ACCB instruction (e.g., similar to or the same as example ACCB instruction 300) for one or more large number integers (e.g., the same large number integers for which CPU 114 performed one or more ACCT instructions). According to implementations, CPU 114 performs steps 605 and 610 concurrently, while in other implementations, steps 605 and 610 are performed sequentially. To perform an ACCB instruction for one or more large number integers, CPU 114 adds a second portion (e.g., bottom portion) of each block of data of the large number integers (e.g., as indicated by bottom lanes 228 of vector register 232) to data in a first lane (e.g., bottom lane 335) of a respective pair of lanes (e.g., top lane 334 and bottom lane 335) of a bottom accumulator 336. In implementations, for each block of data of a large number integer, CPU 114 adds a second portion of a block of data to data in a first lane of a pair of lanes of a second (e.g., bottom) accumulator 336 to produce a second sum (e.g., the sum of the second portion of the block of data and the data in the first lane of the pair of lanes) and a carry-out bit 552. According to implementations, CPU 114 is configured to generate a carry-out bit 552 based on the second sum (e.g., the sum of the second portion of the block of data and the data in the first lane of the pair of lanes). For example, in response to the second sum being equal to or exceeding a threshold value, CPU 114 generates a carry-out bit 552. The carry-out bit 552 includes data, for example, indicating that a value (e.g., 1) is to be added to a second lane (e.g., top lane 334) of the pair of lanes of the bottom accumulator 336. As an example, after generating a carry-out bit 552, CPU 114 adds the carry-out bit 552 to the data stored in the second lane (e.g., top lane 334) of the pair of lanes of the bottom accumulator 336. Once CPU 114 has added a second portion (e.g., bottom portion) of each block of data of one or more large number integers to a first lane (e.g., bottom lane 335) of a respective pair of lanes of bottom accumulator 336 and added each generated carry-out bit 552 to a second lane (e.g., top lane 334) of a respective pair of lanes of bottom accumulator 336, CPU 114 completes the ACCB instruction.

At step 615, in response to CPU 114 completing one or more ACCT instructions and one or more ACCB instructions, CPU 114 is configured to align the data in the top (e.g., first) accumulator 230, bottom (e.g., second) accumulator 336, or both such that the data in the top accumulator 230 is able to be added to the data in the bottom accumulator 336. For example, CPU 114 performs an align command on the data in the top accumulator 230 such that the data in the top accumulator 230 is able to be added to the data in the bottom accumulator 336. At step 620, CPU 114 (e.g., one or more processor cores 116 of CPU 114) adds the data in the top accumulator 230 to the data in the bottom accumulator 336 to produce a result of the computation. For example, CPU 114 performs a full N-bit add (e.g., including carry propagation) to add the data in the top accumulator 230 to the data in the bottom accumulator 336 to produce a large number integer (e.g., 256-bit integer, 512-bit integer, 4096-bit integer). As such, CPU 114 generates the results of the computation using only two instructions (e.g., an ACCT instruction and an ACCB instruction), reducing the number of instructions needed to produce the result when compared to other arithmetic methods (e.g., x86 scalar arithmetic, ARM SVE2 arithmetic) which decreases processing times and increases processing efficiency. According to some implementations, CPU 114 is configured to encrypt and decrypt data using the result of the computation. For example, based on a cryptographic algorithm (e.g., RSA algorithm), CPU 114 uses the result of the computation to encrypt data, decrypt data, or both.

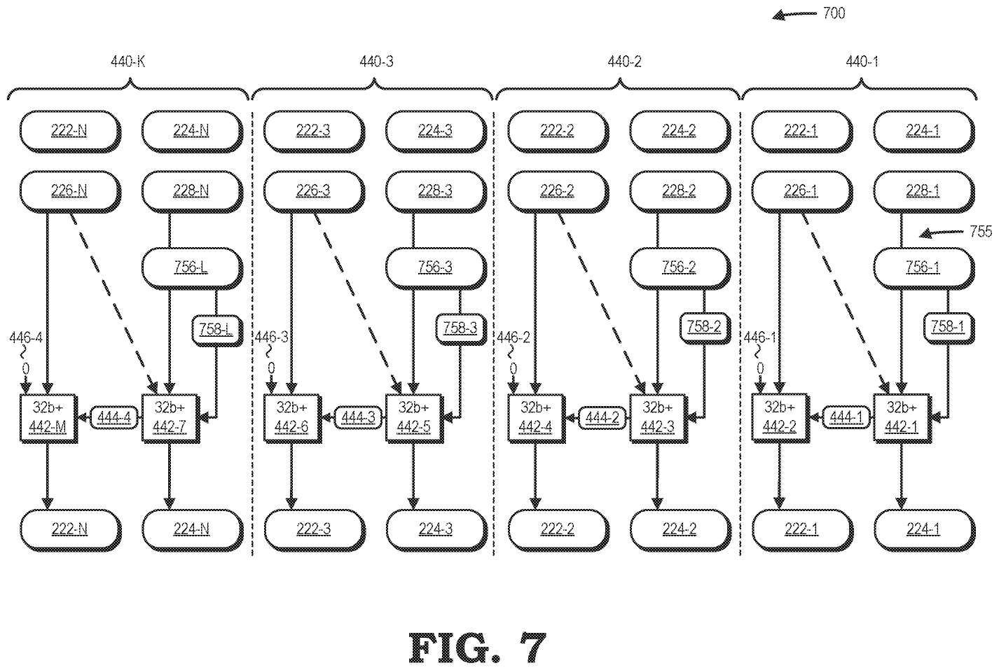

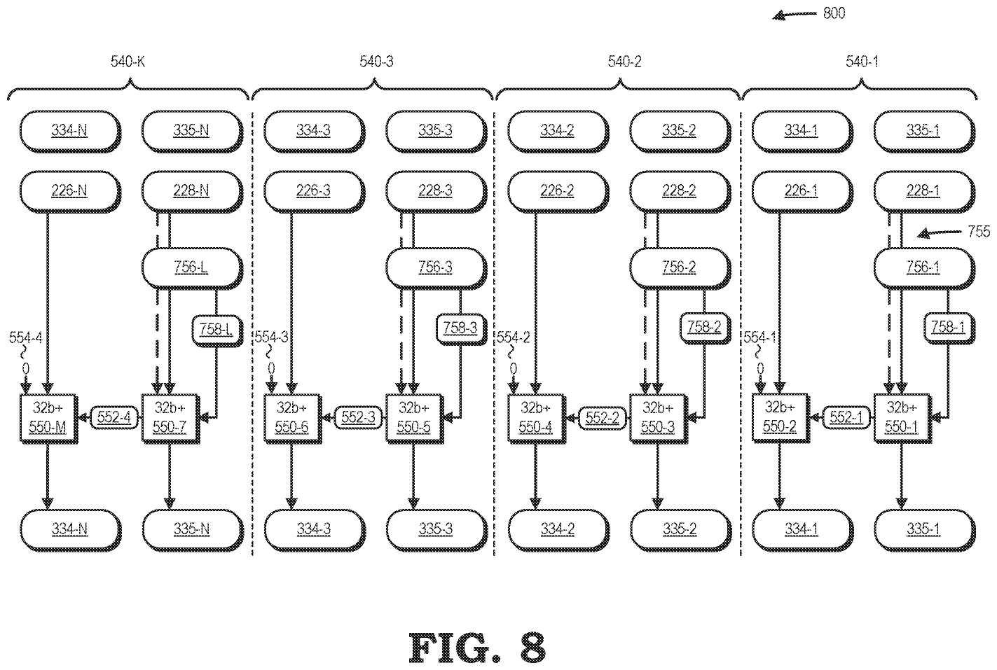

FIGS. 7 and 8 together show ACCT data paths 400 and ACCB data paths 500 including a second vector register 755. Second vector register 755 includes, for example, one or more lanes 756 each storing data indicating a respective carry-in bit 758. Though the example implementations in FIGS. 7 and 8 present second vector register 755 as having four lanes (756-1, 756-2, 756-3, 756-L) representing an L number of lanes 756, in other implementations, second vector register 755 can include any number of lanes 756. Each carry-in bit 758, for example, includes data indicating a value (e.g., 1) is to be added to a lane of top accumulator 230, bottom accumulator 336, or both. According to implementations, CPU 114 is configured to generate one or more carry-in bits 758 and store data indicating the carry-in bits 758 in the lanes 756 of vector register 755 based on one or more computations being performed on a large integer.

Referring now to FIG. 7, an ACCT data path 700, similar to or the same as ACCT data path 400, including second vector register 755 is presented. To this end, each section 440 of ACCT data path 700 includes a respective lane 756 of second vector register 755. For example, section 440-1 includes lane 756-1 of vector register 755, section 440-2 includes lane 756-1 of vector register 755, section 440-3 includes lane 756-3 of vector register 755, and section 440-K includes lane 756-L of vector register 755. Within each section 440, a lane 756 of vector register 755 provides a respective carry-in bit (758-1, 758-2, 758-3, 758-L) to a first adder 442 of the section 440 such that the first adder 442 is configured to add a first (e.g., top) portion of a block of data (e.g., as indicated by a respective top lane 226 of vector register 232 in the section 440), data from a bottom lane 224 of top accumulator 230 in section 440, and carry-in bit 758 to produce a first sum (e.g., the sum of the first portion of a block of data, data from a bottom lane 224 of top accumulator 230, and the carry-in bit 758). According to implementations, after producing the first sum (e.g., the sum of the first portion of a block of data, data from a bottom lane 224 of top accumulator 230, and the carry-in bit 758), an adder 442 is configured to store the first sum in the bottom lane 224 of top accumulator 230 in the same section 440 as the adder 442. For example, within section 440-1, adder 442-1 is configured to store a first sum (e.g., the sum of the first portion of a block of data, data from a bottom lane 224-1 of top accumulator 230, and the carry-in bit 758-1) to the bottom lane 224-1 of top accumulator 230. Further, in some implementations, in response to producing a first sum (e.g., the sum of the first portion of a block of data, data from a bottom lane 224 of top accumulator 230, and the carry-in bit 758), an adder 442 is configured to generate a carry-out bit 444. For example, in response to the first sum being equal to or exceeding a predetermined threshold value, an adder 442 generates a carry-out bit 444. In this way, the carry-in bits 758 of the second vector register 755 are used to generate the first sum and carry-out bits 444 as needed by certain operations.

Referring now to FIG. 8, an ACCB data path 800, similar to or the same as ACCB data path 500, including second vector register 755 is presented. To this end, each section 540 of ACCB data path 800 includes a respective lane 756 of second vector register 755. For example, section 540-1 includes lane 756-1 of vector register 755, section 540-2 includes lane 756-1 of vector register 755, section 540-3 includes lane 756-3 of vector register 755, and section 540-K includes lane 756-L of vector register 755. Within each section 540, a lane 756 of vector register 755 provides a respective carry-in bit 758 to a first adder 550 of the section 540 such that the first adder 550 is configured to add a second (e.g., bottom) portion of a block of data (e.g., as indicated by a respective bottom lane 228 of vector register 232 in the section 540), data from a bottom lane 335 of bottom accumulator 336 in section 540, and carry-in bit 758 to produce a second sum (e.g., the sum of the second portion of a block of data, data from a bottom lane 335 of bottom accumulator 336, and the carry-in bit 758). In implementations, after producing the second sum (e.g., the sum of the second portion of a block of data, data from a bottom lane 335 of bottom accumulator 336, and the carry-in bit 758), an adder 550 is configured to store the second sum in the bottom lane 335 of bottom accumulator 336 in the same section 540 as the adder 550. For example, within section 540-K, adder 550-M is configured to store a second sum (e.g., the sum of the second portion of a block of data, data from a bottom lane 335-N of bottom accumulator 336, and the carry-in bit 758-4) to the bottom lane 335-N of bottom accumulator 336. Further, in some implementations, in response to producing a second sum (e.g., the sum of the second portion of a block of data, data from a bottom lane 335 of bottom accumulator 336, and the carry-in bit 758), an adder 550 is configured to generate a carry-out bit 552. For example, in response to the second sum being equal to or exceeding a predetermined threshold value, an adder 550 generates a carry-out bit 552. As such, the carry-in bits 758 of the second vector register 755 are used to generate the second sum and carry-out bits 552 as needed by certain operations.

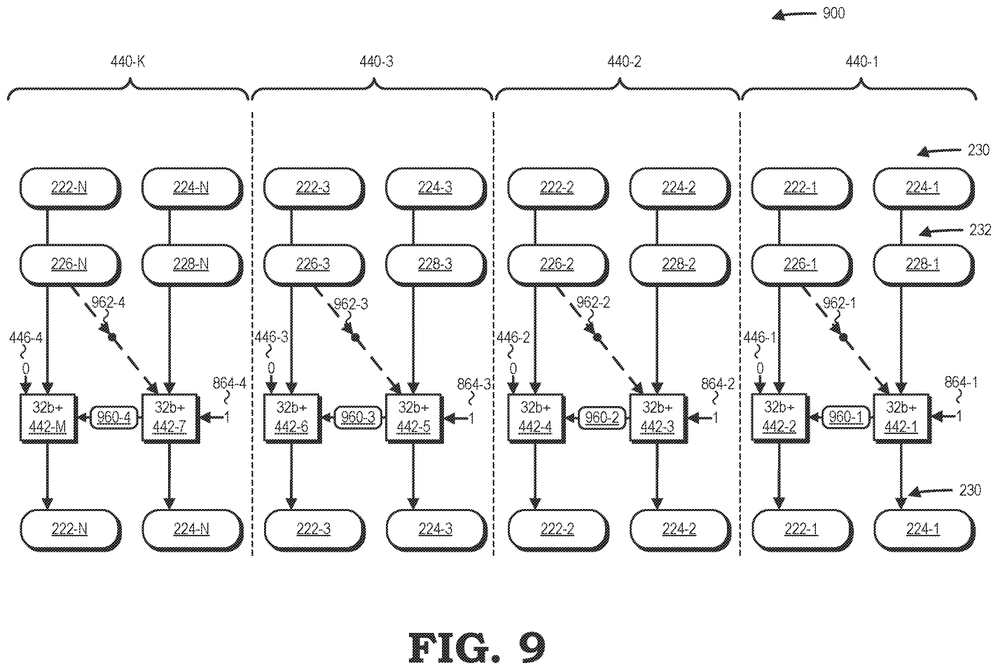

Referring now to FIG. 9, a subtract accumulate top (SUBACCT) data path 900 for handling one or more SUBACCT instructions is presented. SUBACCT data path 900 is similar to ACCT data path 400 but also includes one or more inverters 962. In implementations, a SUBBACCT instruction is an inverse of an ACCT instruction wherein a first (e.g., top) portion of each block of data of one or more large number integers is subtracted from a bottom lane (e.g., bottom lane 224) of top accumulator 230 rather than added to the bottom lane of the top accumulator 230 as in an ACCT instruction. To this end, each section 440 of SUBACCT data path 900 includes an inverter 962 configured to invert the portion (e.g., top portion) of the block of a large integer indicated by the top lane 226 of vector register 232 included in the section 440. For example, section 440-1 includes inverter 962-1 configured to invert a portion (e.g., top portion) of a block of data indicated by top lane 226-1 of vector register 232, section 440-2 includes inverter 962-2 configured to invert a portion (e.g., top portion) of a block of data indicated by top lane 226-2 of vector register 232, section 440-3 includes inverter 962-3 configured to invert a portion (e.g., top portion) of a block of data indicated by top lane 226-3 of vector register 232, and section 440-K includes inverter 962-4 configured to invert a portion (e.g., top portion) of a block of data indicated by top lane 226-N of vector register 232.

Further, within each section 440, an adder 442 is configured to receive the inverted portion (e.g., top portion) of a block of data indicated by a top lane 226 of vector register 232 within the section 440, data from a bottom lane 224 of top accumulator 230 in the section 440, and a carry-in bit 864. Such a carry-in bit 864, for example, indicates a value (e.g., 1) to be added to the data in a bottom lane 224 of top accumulator 230 before a portion (e.g., top portion) of a block of data is to be subtracted from the data in a bottom lane 224 of top accumulator 230. In response to receiving the inverted portion (e.g., top portion) of a block of data indicated by a top lane 226 of vector register 232 within the section 440, data from a bottom lane 224 of top accumulator 230 in the section 440, and a respective carry-in bit (864-1, 864-2, 864-3, 864-4), an adder 442 is configured to produce a first sum (e.g., the sum of the inverted portion of a block of data, data from a bottom lane 224 of top accumulator 230, and a carry-in bit 864). The adder 442 then stores the first sum (e.g., the sum of the inverted portion of a block of data, data from a bottom lane 224 of top accumulator 230, and a carry-in bit 864) in the bottom lane 224 of top accumulator 230 in the same section 440 as the adder. For example, within section 440-1, a first adder 442-1 is configured to receive an inverted portion (e.g., top portion) of a block of data from inverter 962-1, data from bottom lane 224 of top accumulator 230, and carry-in bit 864-1 and produce a first sum (e.g., the sum of the inverted portion of a block of data, data from bottom lane 224-1 of top accumulator 230, and carry-in bit 864-1). Further, the first adder 442-1 is configured to store such a first sum in bottom lane 224-1 of top accumulator 230. In this way, SUBACCT data path 900 is configured to subtract a first portion (e.g., top portion) of each block of data of one or more large number integers from the respective bottom lanes 224 of top accumulator 230.

Further, in some implementations, an adder 442 is configured to generate a carry-out bit 960 (e.g., similar to or the same as carry-out bit 444) based on the first sum (e.g., the sum of the inverted portion of a block of data, data from a bottom lane 224 of top accumulator 230, and a carry-in bit 864). For example, in response to the first sum being equal to or exceeding a predetermined threshold value, an adder 442 generates a carry-out bit 960. Additionally, the adder 442 is configured to provide the carry-out bit 960 to a second adder 442 in the same section 440. For example, in section 440-1, adder 442-1 provides carry-out bit 960-1 to adder 442-2, in section 440-2, adder 442-3 provides carry-out bit 960-2 to adder 442-4, in section 440-3, adder 442-5 provides carry-out bit 960-3 to adder 442-6, and in section 440-K, adder 442-7 provides carry-out bit 960-4 to adder 442-M. In response to receiving a carry-out bit 960, an adder 442 is configured to add the carry-out bit 960 to a top lane 222 of top accumulator 230 in the same section 440 as the adder. In this way, SUBACCT data path 900 is configured to carry the carry-out bits 960 through multiple accumulations (e.g., multiple SUBACCT instructions).

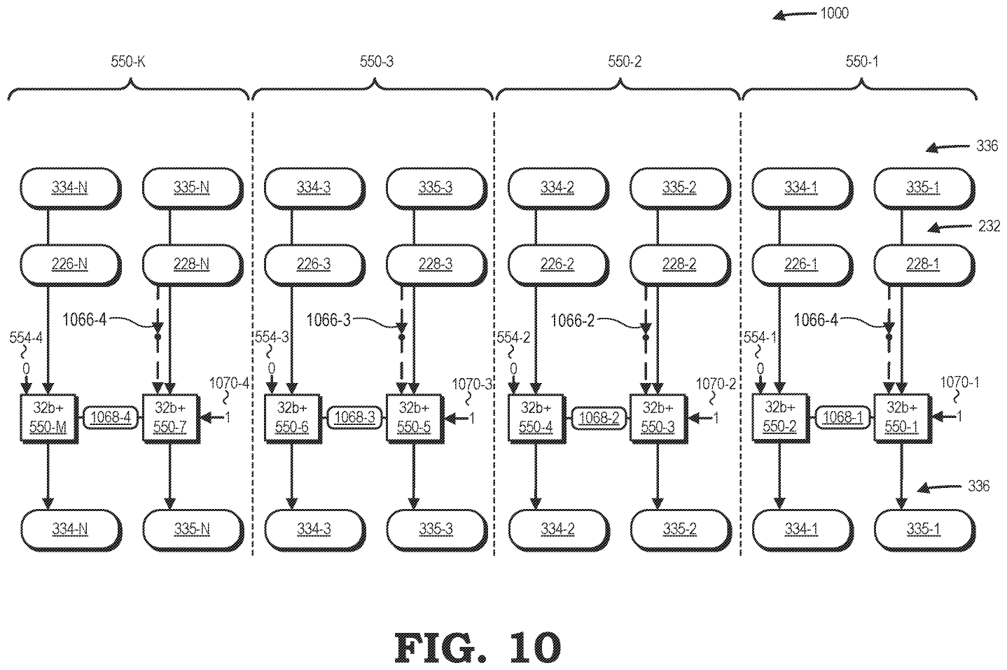

Referring now to FIG. 10, a subtract accumulate bottom (SUBACCB) data path 1000 for handling one or more SUBACCB instructions is presented. SUBACCB data path 1000 is similar to ACCB data path 500 but includes one or more inverters 1066. In implementations, a SUBBACCB instruction is an inverse of an ACCB instruction wherein a second (e.g., bottom) portion of each block of data of one or more large number integers is subtracted from a bottom lane (e.g., bottom lane 335) of bottom accumulator 336 rather than added to the bottom lane of the bottom accumulator 336 as in an ACCB instruction. In implementations, each section 540 of SUBACCT data path 1000 includes an inverter 1066 configured to invert the portion (e.g., bottom portion) of the block of a large integer indicated by the bottom lane 228 of vector register 232 included in the section 540. For example, section 540-1 includes inverter 1066-1 configured to invert a portion (e.g., bottom portion) of a block of data indicated by bottom lane 228-1 of vector register 232, section 540-2 includes inverter 1066-2 configured to invert a portion (e.g., bottom portion) of a block of data indicated by bottom lane 228-2 of vector register 232, section 540-3 includes inverter 1066-3 configured to invert a portion (e.g., bottom portion) of a block of data indicated by bottom lane 228-3 of vector register 232, and section 540-K includes inverter 1066-4 configured to invert a portion (e.g., bottom portion) of a block of data indicated by bottom lane 228-N of vector register 232.

Additionally, within each section 540, a first adder 550 is configured to receive the inverted portion (e.g., bottom portion) of a block of data indicated by a bottom lane 228 of vector register 232 within the section 540, data from a bottom lane 335 of bottom accumulator 336 in the section 540, and a carry-in bit 1070. Such a carry-in bit (1070-1, 1070-2, 1070-3, 1070-4), for example, indicates a value (e.g., 1) to be added to the data in a bottom lane 335 of bottom accumulator 336 before a portion (e.g., bottom portion) of a block of data is to be subtracted from the data in the bottom lane 335 of bottom accumulator 336. In response to receiving the inverted portion (e.g., bottom portion) of a block of data indicated by a bottom lane 228 of vector register 232 within the section 540, data from a bottom lane 335 of bottom accumulator 336 in the section 540, and a carry-in bit 1070, an adder 550 is configured to produce a second sum (e.g., the sum of the inverted portion of a block of data, data from a bottom lane 335 of bottom accumulator 336, and a carry-in bit 1070). The adder 550 then stores the second sum (e.g., the sum of the inverted portion of a block of data, data from a bottom lane 335 of bottom accumulator 336, and a carry-in bit 1070) in the bottom lane 335 of bottom accumulator 336 in the same section 540 as the adder 550. For example, within section 540-K, a first adder 550-7 is configured to receive an inverted portion (e.g., bottom portion) of a block of data from inverter 1066-4, data from bottom lane 335-N of bottom accumulator 336, and carry-in bit 1070-4 and produce a second sum (e.g., the sum of the inverted portion of a block of data, data from bottom lane 335-N of bottom accumulator 336, and carry-in bit 1070-4). Further, the first adder 550-7 is configured to store such a second sum in bottom lane 335-N of bottom accumulator 336. As such, SUBACCB data path 1000 is configured to subtract a second portion (e.g., bottom portion) of each block of data of one or more large number integers from the respective bottom lanes 335 of bottom accumulator 336.

According to implementations, an adder 550 is configured to generate a carry-out bit 1068 (e.g., similar to or the same as carry-out bit 552) based on the second sum (e.g., the sum of the inverted portion (e.g., bottom portion) of a block of data, data from a bottom lane 335 of bottom accumulator 336, and a carry-in bit 1070). For example, in response to the second sum being equal to or exceeding a predetermined threshold value, an adder 550 generates a carry-out bit 1068. Additionally, the adder 550 is configured to provide the carry-out bit 1068 to a second adder 550 in the same section 540. For example, in section 540-1, adder 550-1 provides carry-out bit 1068-1 to adder 550-2, in section 540-2, adder 550-3 provides carry-out bit 1068-2 to adder 550-4, in section 540-3, adder 550-5 provides carry-out bit 1068-3 to adder 550-6, and in section 540-K, adder 550-7 provides carry-out bit 1068-4 to adder 550-M. In response to receiving a carry-out bit 1068, an adder 550 is configured to add the carry-out bit 1068 to a top lane 334 of bottom accumulator 336 in the same section 540 as the adder 550. By adding the carry-out bits 1068 in this way, SUBACCB data path 1000 is configured to carry the carry-out bits 1068 through multiple accumulations (e.g., multiple SUBACCB instructions).

In some implementations, the apparatus and techniques described above are implemented in a system including one or more integrated circuit (IC) devices (also referred to as integrated circuit packages or microchips), such as the processor described above with reference to FIGS. 1-10. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM), or other non-volatile memory device or devices, and the like. The executable instructions stored on the non-transitory computer-readable storage medium may be in source code, assembly language code, object code, or another instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still, further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A processor comprising:
one or more processor cores, wherein a processor core of the one or more processor cores includes a first data path configured to:
add a first portion of a block of data to a first lane of a set of lanes of a first accumulator to produce a first sum and a first carry-out bit;
store the first sum in the first lane of the set of lanes of the first accumulator; and
add the first carry-out bit to a second lane of the set of lanes of the first accumulator.

2. The processor of claim 1, wherein the processor core further includes a second data path configured to:
add a second portion of the block of data to a first lane of a set of lanes of a second accumulator to produce a second sum and a second carry-out bit;
store the second sum in the first lane of the set of lanes of the second accumulator; and
add the first carry-out bit to a second lane of the set of lanes of the second accumulator,
wherein the first portion of the block of data is different from the second portion of the block of data.

3. The processor of claim 2, wherein the first portion of the block of data includes a most significant bit of the block of data and the second portion of the block of data includes a least significant bit of the block of data.

4. The processor of claim 2, wherein the one or more processor cores are configured to add data from the first accumulator to data from the second accumulator.

5. The processor of claim 4, wherein the one or more processor cores are configured to encrypt and decrypt data based on a sum of the data from the first accumulator and the data from the second accumulator.

6. The processor of claim 1, wherein the first data path comprises a first adder configured to:
add the first portion of the block of data to data in the first lane of the set of lanes of the first accumulator to produce the first sum; and
generate the first carry-out bit based on the first sum.

7. The processor of claim 1, wherein the first data path includes one or more inverters configured to invert the first portion of the block of data.

8. A method comprising:
adding, by a first data path, a first portion of a block of data to a first lane of a set of lanes of a first accumulator to produce a first sum and a first carry-out bit;
storing, by the first data path, the first sum in the first lane of the set of lanes of the first accumulator; and
adding the first carry-out bit to a second lane of the set of lanes of the first accumulator.

9. The method of claim 8, further comprising:
adding, by a second data path, a second portion of the block of data to a first lane of a set of lanes of a second accumulator to produce a second sum and a second carry-out bit;
storing, by the second data path, the second sum in the first lane of the set of lanes of the second accumulator; and
adding the first carry-out bit to a second lane of the set of lanes of the second accumulator,
wherein the first portion of the block of data is different from the second portion of the block of data.

10. The method of claim 9, wherein the first portion of the block of data includes a most significant bit of the block of data and the second portion of the block of data includes a least significant bit of the block of data.

11. The method of claim 9, further comprising adding data from the first accumulator to data from the accumulator.

12. The method of claim 11, further comprising:
encrypting or decrypting data based on a sum of the data from the first accumulator and the data from the second accumulator.

13. The method of claim 8, further comprising:
adding, the first data path, the first portion of the block of data to data in the first lane of the set of lanes of the first accumulator to produce the first sum; and
generating the first carry-out bit based on the first sum.

14. The method of claim 8, further comprising:
inverting, by the first data path, the first portion of the block of data.

15. A processor, comprising:
one or more processor cores, wherein a processor core of the one or more processor cores includes a first data path configured to:
store a first sum of a first portion of a block of data and data in a first lane of a set of lanes of a first accumulator in the first lane of the set of lanes of the first accumulator; and
based on the first sum, add a first carry-out bit to a second lane of the set of lanes of the first accumulator.

16. The processor of claim 15, wherein the processor core further includes a second data path configured to:
store a second sum of a second portion of a block of data and data in a first lane of a set of lanes of a second accumulator in the first lane of the set of lanes of the second accumulator; and
based on the second sum, add a second carry-out bit to a second lane of the set of lanes of the second accumulator,
wherein the first portion of the block of data is different from the second portion of the block of data.

17. The processor of claim 16, wherein the first portion of the block of data includes a most significant bit of the block of data and the second portion of the block of data includes a least significant bit of the block of data.

18. The processor of claim 16, wherein the one or more processor cores are configured to add data from the first accumulator to data from the second accumulator.

19. The processor of claim 18, wherein the one or more processor cores are configured to encrypt and decrypt data based on a sum of the data from the first accumulator and the data from the second accumulator.

20. The processor of claim 15, wherein the first data path comprises a first adder configured to:
add the first portion of the block of data to the data in the first lane of the set of lanes of the first accumulator to produce the first sum; and
generate the first carry-out bit based on the first sum.
